(19) United States
(12) Patent Application Publication
(10) Pub. No.: US 2013/0036071 A1
(43) Pub. Date: Feb. 7, 2013

(54) DYNAMIC COMMODITY INDEX METHODOLOGY

(71) Applicants: K. Geert ROUWENHORST, Stamford, CT (US); Adam Dunsby, Stamford, CT (US); Kurt J. Nelson, Stamford, CT (US); Ashraf R. Rizvi, Stamford, CT (US)

(72) Inventors: K. Geert ROUWENHORST, Stamford, CT (US); Adam Dunsby, Stamford, CT (US); Kurt J. Nelson, Stamford, CT (US); Ashraf R. Rizvi, Stamford, CT (US)

(73) Assignee: SUMMERHAVEN INDEX MANAGEMENT LLC

(21) Appl. No.: 13/560,553

(22) Filed: Jul. 27, 2012

Related U.S. Application Data
(60) Provisional application No. 61/457,993, filed on Jul. 29, 2011.

(51) Int. Cl. G06Q 40/06

(52) U.S. Cl. 705/36 R

(57) ABSTRACT

A rules-based commodity index methodology which is based on the performance of a fully margined or collateralized portfolio of 14 futures contracts with equal weights from six commodity sectors: energy, precious metals, industrial metals, grains, softs and livestock.

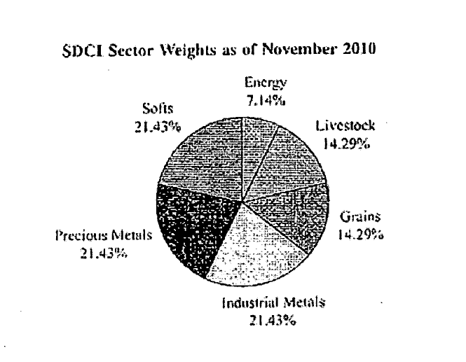

### CROSS-REFERENCE TO RELATED APPLICATION

This application derives from U.S. Provisional Application Ser. No. 61/457,993, filed Jul. 29, 2011, the priority of which is claimed.

### BACKGROUND OF INVENTION

### Field of the Invention

This invention relates to the determination, using a computer, of a commodity index that is of value to investors in making decisions regarding the advisability of investing in commodities.

### SUMMARY OF THE INVENTION

The SummerHaven Dynamic Commodity Index (Commodity Index) is designed to reflect the performance of a fully margined or collateralized portfolio of 14 commodity futures contracts with equal weights, selected each month from a universe of the 27 commodity futures contracts. The Commodity Index is rules-based and rebalanced monthly based on observable price signals. In this context, the term “rules-based” is meant to indicate that the composition of the Commodity Index in any given month will be determined by quantitative formulas relating to the prices of the futures contracts that relate to the commodities that are eligible to be included in the Commodity Index. Such formulas are not subject to adjustment based on other factors. The overall return on the Commodity Index is generated by two components: (i) uncollateralized returns from the benchmark component commodity futures contracts comprising the Commodity Index and (ii) a daily fixed income return reflecting the interest earned on a hypothetical 3-month U.S. Treasury Bill collateral portfolio, calculated using the weekly auction rate for the 3-month U.S. treasury bills published by the U.S. Department of the Treasury.

The Commodity Index is composed of physical non-financial commodity futures contracts with active and liquid markets traded upon futures exchange in major industrialized countries. The futures contracts are denominated in U.S. dollars and weighted equally by notional amount. The Commodity Index currently reflects commodities in six commodity sectors: energy (e.g., crude oil, natural gas, heating oil, etc.) precious metals (e.g., gold, silver platinum), industrial metals (e.g., zinc, nickel, aluminum, copper, etc.), grains (e.g., wheat, corn, soybeans, etc.), softs (e.g., sugar, cotton, coffee, cocoa), and livestock (e.g., live cattle, lean hogs, feeder cattle).

Table 1 below lists the eligible commodities, the relevant future exchanges on which the eligible commodity futures contracts are listed and quotation details. Table 1 lists the eligible commodity futures contracts, their sector designation and maximum allowable tenor.

TABLE 1

| Commodity | Designated Contract | Exchange | Units | | Quote |
|---|---|---|---|---|---|
| Crude Oil (Brent) | Crude Oil | ICE-UK | 1,000 | barrels | USD/barrel |
| Crude Oil (WTI) | Light, Sweet Crude Oil | NYMEX | 1.000 | barrels | USD/barrel |
| Gas Oil | Gas Oil | ICE-UK | 100 | metric tons | USD/metric ton |
| Healing Oil | Heating Oil | NYMEX | 42,000 | gallons | U.S. cents/gallon |
| Natural Gas | Henry Hub Natural Gas | NYMEX | (0.000 | mmbtu | USD/1111111)M |
| Unleaded Gasoline | Reformulated Blendstock for | NYMEX | 42,000 | gallons | U.S. cents/gallon |
| | Oxygen Blending “RBOB” | | | | |
| Feeder Cattle | Feeder Cattle | CME | 50,000 | lbs. | U.S. cents/pound |
| Lean Hogs | Lean Hogs | CME | 40,000 | lbs. | U.S. cents/pound |
| Live Cattle | Live Cattle | CME | 40,000 | lbs. | U.S. cents/pound |
| Soybean Oil | Soybean Oil | CBOT | 60,000 | lbs. | U.S. cents/pound |
| Corn | Corn | CBOT | 5,000 | bushels | U.S. cents/bushel |
| Soybeans | Soybeans | CBOT | 5,000 | bushels | U.S. cents/bushel |
| Soybean Meal | Soybean Meal | CBOT | 100 | tons | USD/ton |
| Wheat | Wheat (Soft Red Winter) | CBOT | 5,000 | bushels | U.S. cents/bushel |
| (Soft Red Winter) | | | | | |
| Aluminum | High Grade Primary Aluminum | LME | 25 | metric tons | USD/metric ton |
| Copper | Copper | COMEX | 25,000 | lbs | U.S. cents/pound |
| Lead | Lead | LME | 25 | metric tons | USD/metric ton |
| Nickel | Primary Nickel | LME | 6 | metric tons | USD/metric ton |
| Tin | Tin | LME | 5 | metric tons | USD/metric ton |
| Zinc | Special High Grade Zinc | LME | 25 | metric tons | USD/metric ton |
| Gold | Gold | COMEX | 100 | troy oz. | USD/troy oz. |
| Platinum | Platinum | NYMEX | 50 | troy Ox. | USD/troy oz. |
| Silver | Silver | COMEX | 5,000 | troy oz. | U.S. cents/troy/oz. |
| Cocoa | Cocoa | ICE-US | 10 | metric tons | USD/metric ton |
| Coffee | Coffee “C” | ICE-US | 37,500 | lbs. | U.S. cents/pound |
| Cotton | Cotton | ICE-US | 50,000 | lbs. | U.S. cents/pound |
| Sugar | World Sugar No. 11 | ICE-US | 112,000 | lbs. | U.S. cents/pound |

TABLE 2

| Commodity | | | | |
|---|---|---|---|---|
| Symbol | Commodity Name | Sector | Allowed Contracts | Max. tenor |
| CO | Brent Crude | Energy | All 12 Calendar Months | 12 |
| CL | Crude Oil | Energy | All 12 Calendar Months | 12 |
| QS | Gas Oil | Energy | All 12 Calendar Months | 12 |
| HO | Heating Oil | Energy | All 12 Calendar Months | 12 |
| NG | Natural Gas | Energy | All 12 Calendar Months | 12 |
| XB | RBOB | Energy | All 12 Calendar Months | 12 |
| FC | Feeder Cattle | Livestock | January, March, April, May, August, September, October, | 5 |
| | | | Novemeber | |
| LH | Lean Hogs | Livestock | February, April, June, July, August, October, December | 5 |
| LC | Live Cattle | Livestock | February, April, June, August, October, December | 5 |
| BO | Soybean Oil | Grains | January, March, May, July, August, September, October, | 7 |
| | | | December | |
| C | Corn | Grains | March, May, July, September, December | 12 |
| S | Soybeans | Grains | January, March, May, July, August, September, Novemeber | 12 |
| SM | Soymeal | Grains | January, March, May, July, August, September, October, | 7 |
| | | | December | |
| W | Wheat (Soft Red Winter) | Grains | March, May July, September, December | 7 |
| LA | Aluminum | Industrial Metals | All 12 Calendar months | 12 |
| HG | Copper | Industrial Metals | All 12 Calendar months | 12 |
| LL | Lead | Industrial Metals | All 12 Calendar months | 7 |
| LN | Nickel | Industrial Metals | All 12 Calendar months | 7 |
| LT | Tin | Industrial Metals | All 12 Calendar months | 7 |
| LX | Zinc | Industrial Metals | All 12 Calendar months | 7 |
| GC | Gold | Precious Metals | February, April, June, August, October, December | 12 |
| PL | Platinum | Precious Metals | January, April, July, October | 5 |
| SI | Silver | Precious Metals | March, May, July, September, December | 5 |
| CC | Cocoa | Softs | March, May, July, September, December | 7 |
| KC | Coffee | Softs | March, May, July, September, December | 7 |
| CT | Cotton | Softs | March, May July, December | 7 |
| SB | Sugar | Softs | March, May, July, October | 7 |

Prior to the end of each month, the composition of the Commodity Index is determined and such information is provided to Bloomberg, L.P. Values of the Commodity Index are computed by Bloomberg, L.P. and disseminated approximately every fifteen (15) seconds from 8:00 a.m. to 5:00 p.m., New York City time, which also publishes a daily Commodity Index value at approximately 5:30 p.m., New York City time, under the index ticker symbol “SDCITR:IND”. Only settlement and last-sale prices are used in the Commodity Index's calculation, bids and offers are not recognized—including limit-bid and limit-offer price quotes. Where no last-sale price exists, typically in the more deferred contract months, the previous days' settlement price is used. This means that the underlying Commodity Index may lag its theoretical value. This tendency to lag is evident at the end of the day when the Commodity Index value is based on the settlement prices of the Benchmark Component Commodity Futures Contracts, and explains why the underlying Commodity Index often closes at or near the high or low for the day.

### Composition of the Commodity Index

The composition of the Commodity Index on any given day, as determined and published by SummerHaven Index Management LLC, is determinative of the benchmark for U.S. Commodity Index Fund.

### Contract Expirations

Because the Commodity Index is comprised of actively traded contracts with scheduled expirations, it can by calculated only by reference to the prices of contracts for specific expiration, delivery or settlement periods, referred to as contract expirations. The contract expirations included in the Commodity Index for each commodity during a given year are designated by SummerHaven Index Management LLC, provided that each contract must be an active contract. An active contract for this purpose is a liquid, actively-traded contract expiration, as defined or identified by the relevant trading facility or, if no such definition or identification is provided by the relevant trading facility, as defined by standard custom and practice in the industry.

If a futures exchange ceases trading in all contract expirations relating to a commodity futures contract, SummerHaven Index Management LLC may designate a replacement contract on the commodity. The replacement contract must satisfy the eligibility criteria for inclusion in the Commodity Index. To the extent practicable, the replacement will be effected during the next monthly review of the composition of the Commodity Index. If that timing is not practicable, SummerHaven Index Management LLC will determine the date of the replacement based on a number of factors, including the differences between the existing component commodity futures contract and the replacement contract with respect to contractual specification and contract expirations.

If a component commodity futures contract is eliminated and there is no replacement contract, the underlying commodity will necessarily drop out of the Commodity Index. The designation of a replacement contract, or the elimination of a commodity from the Commodity Index because of the absence of a replacement contract, could affect the value of the Commodity Index, either positively or negatively, depending on the price of the contract that is eliminated and the prices of the remaining contracts.

### Commodity Selection

14 of the 27 commodity future contracts are selected for inclusion in the Commodity Index for the next month, subject to the constraint that each of the six commodity sectors is represented by at least one commodity. The methodology used to select the 14 component Commodity futures contracts is based solely on quantitative data using observable futures prices and is not subject to human bias.

Monthly commodity selection is a two-step process based upon examination of the relevant futures prices for each commodity:

1) The annualized percentage price difference between the closest-to-expiration component commodity futures contract and the next closest-to-expiration component commodity futures contract is calculated for each of the 27 commodity futures contracts on the Selection Date. The seven commodities with the highest percentage price difference are selected. A hypothetical example is included below, with the seven selected commodities shaded below:

| | Percentage | |
|---|---|---|
| | Price | |
| Eligible Commodity | Difference | Ranking |
| Crude Oil (Brent) | −4.75% | 13 |
| Crude Oil (WTI) | −5.01% | 14 |
| Gas Oil | 20.78% | 1 |
| Heating Oil | −7.87% | 21 |
| Natural Gas | −19.92% | 25 |
| Unleaded Gasoline (RBOB) | 1.27% | 5 |
| Feeder Cattle | −27.42% | 27 |
| Lean Hogs | −20.68% | 26 |
| Live Cattle | 14.31% | 3 |
| Soybean Oil | −6.70% | 20 |
| Corn | −17.58% | 24 |
| Soybeans | −5.12% | 16 |
| Soybean Meal | 3.23% | 4 |
| Wheat (Soft Red Winter) | −15.41% | 23 |
| Aluminum | −6.61% | 19 |
| Copper | −0.69% | 9 |
| Lead | −4.66% | 12 |
| Nickel | −0.57% | 6 |
| Tin | −1.83% | 11 |
| Zinc | −5.33% | 17 |
| Gold | −0.64% | 8 |
| Platinum | −1.42% | 10 |
| Silver | −0.62% | 7 |
| Cocoa | −5.09% | 15 |
| Coffee | −10.26% | 22 |
| Cotton | −6.18% | 18 |
| Sugar | 16.81 | 2 |

For the remaining 20 eligible commodities, the percentage price change of each commodity over the previous year is calculated, as measured by the change in the price or the closest-to-expiration commodity futures contract on the selection date from the price or the closest-to-expiration commodity futures contract a year prior to the selection date. The seven commodities with the highest percentage price change are selected. A hypothetical example is included below, with the next seven selected commodities shaded below (the selected commodities are ranked 1-7):

| | Percentage | |
|---|---|---|
| | Price | |
| Eligible Commodity | Change | Ranking |
| Crude Oil (Brent) | 40.26% | 10 |
| Crude Oil (WTI) | 68.10% | 6 |
| Heating Oil | 67.65% | 7 |
| Natural Gas | 10.88% | 17 |
| Feeder Cattle | 12.41% | 16 |
| Lean Hogs | 17.07% | 14 |
| Soybean Oil | 26.94% | 11 |
| Corn | −3.16% | 19 |
| Soybeans | 4.86% | 18 |
| Wheat (Soft Red Winter) | −7.69% | 20 |
| Aluminum | 66.67% | 8 |
| Copper | 88.22% | 3 |
| Lead | 73.54% | 5 |
| Tin | 77.57% | 4 |
| Zinc | 97.61% | 1 |
| Gold | 15.77% | 15 |
| Platinum | 56.47% | 9 |
| Cocoa | 18.03% | 12 |
| Coffee | 17.68% | 13 |
| Cotton | 97.05% | 2 |

When evaluating the data from the second step all six commodity sectors must be represented. If the selection of the seven additional commodities with the highest price change fails to meet the overall diversification requirement that all six commodity sectors are represented in the Commodity Index, the commodity with the highest price change among the commodities of the omitted sector(s) would be substituted for the commodity with the lowest price change among the seven additional commodities.

The 14 commodities selected are included in the Commodity Index for the next month on an equally-weighted basis. Due to the dynamic monthly commodity selection, the sector weights will vary from approximately 7% to 43% over time, depending on the price observations each mouth. The selection date for the Commodity Index is the fifth business day prior to the first business day of the next calendar month.

The attached FIGURE shows the sector weights of the commodities selected for inclusion in the Commodity Index as of November 2010.

### CONTRACT SELECTION

For each commodity selected for inclusion into the Commodity Index for that month, the Commodity Index selects a specific component commodity futures contract with a tenor (i.e., contract month) among the eligible tenors (the range of contract months) based upon the relative prices of the component commodity futures contracts within the eligible range of contract months. The previous notwithstanding, the contract expiration is not changed for that month if a contract remains in the Commodity Index, as long as the contract does not enter expire or enter its notice period in the subsequent month.

### Portfolio Construction

The portfolio rebalancing takes place during the rebalancing period. At the end of each of the days in the Rebalancing Period one fourth of the prior month portfolio positions are replaced by an equally-weighted position in the commodity contracts determined on the selection date. At the end of the rebalancing period, the Commodity Index takes an equal-weight position of approximately 7.14% in each of the selected commodity contracts.

### Commodity Index Return Calculation

The percentage excess return equals the percentage change of the market values of the underlying commodity futures. During the rebalancing period, the Commodity Index changes its contract holdings during a four day period.

The value of the SDCI Excess Return (ticker symbol “SDCI ER”) at the end of a business day “t” is equal to the SDCI ER value on day “t-1” multiplied by the sum of the daily percentage price changes of each commodity future factoring in each respective commodity future's notional holding on day “t-1”.

### Rebalancing Period

The Commodity Index is rebalanced during the rebalancing period. At the end of the first date of the rebalancing period, the signals are observed and on the second day a new portfolio is constructed that is equally weighted in terms of notional positions in the newly selected contracts.

### Total Return Calculation

The value of the SDCI Total Return (“SDCI TR”) on any business day is equal to the product of (i) the value of the SDCI TR on the immediately preceding business day multiplied by (ii) one plus the sum of the day's SDCI ER returns and one business day's interest from the hypothetical treasury bill portfolio. The value of the SDCI TR will be calculated and published by Bloomberg, L.P.

Commodity Index Base Level

The SDCI TR was set to 100 on Jan. 2, 1991.

We claim:

1. A method, using a computer, of providing a commodity index for investors which comprises the steps of
(a) determining with a computer an annualized percentage price difference between the closest-to-expiration benchmark component commodity futures contract and the next closest-to-expiration benchmark component commodity futures contract for each of the following twenty-seven commodities as on the following exchanges using the units as follows:
TABLE 1

| Commodity | Designated Contract | Exchange | Units | | Quote |
|---|---|---|---|---|---|
| Crude Oil (Brent) | Crude Oil | ICE-UK | 1,000 | barrels | USD/barrel |
| Crude Oil (WTI) | Light, Sweet Crude Oil | NYMEX | 1.000 | barrels | USD/barrel |
| Gas Oil | Gas Oil | ICE-UK | 100 | metric tons | USD/metric ton |
| Healing Oil | Heating Oil | NYMEX | 42,000 | gallons | U.S. cents/gallon |
| Natural Gas | Henry Hub Natural Gas | NYMEX | (0.000 | mmbtu | USD/1111111)M |
| Unleaded Gasoline | Reformulated | NYMEX | 42,000 | gallons | U.S. cents/gallon |
| | Blendstock for Oxygen | | | | |
| | Blending “RBOB” | | | | |
| Feeder Cattle | Feeder Cattle | CME | 50,000 | lbs. | U.S. cents/pound |
| Lean Hogs | Lean Hogs | CME | 40,000 | lbs. | U.S. cents/pound |
| Live Cattle | Live Cattle | CME | 40,000 | lbs. | U.S. cents/pound |
| Soybean Oil | Soybean Oil | CBOT | 60,000 | lbs. | U.S. cents/pound |
| Corn | Corn | CBOT | 5,000 | bushels | U.S. cents/bushel |
| Soybeans | Soybeans | CBOT | 5,000 | bushels | U.S. cents/bushel |
| Soybean Meal | Soybean Meal | CBOT | 100 | tons | USD/ton |
| Wheat | Wheat (Soft Red Winter) | CBOT | 5,000 | bushels | U.S. cents/bushel |
| (Soft Red Winter) | | | | | |
| Aluminum | High Grade Primary Aluminum | LME | 25 | metric tons | USD/metric ton |
| Copper | Copper | COMEX | 25,000 | lbs | U.S. cents/pound |
| Lead | Lead | LME | 25 | metric tons | USD/metric ton |
| Nickel | Primary Nickel | LME | 6 | metric tons | USD/metric ton |
| Tin | Tin | LME | 5 | metric tons | USD/metric ton |
| Zinc | Special High Grade Zinc | LME | 25 | metric tons | USD/metric ton |
| Gold | Gold | COMEX | 100 | troy oz. | USD/troy oz. |
| Platinum | Platinum | NYMEX | 50 troy | Ox. | USD/troy oz. |
| Silver | Silver | COMEX | 5,000 | troy oz. | U.S. cents/troy/oz. |
| Cocoa | Cocoa | ICE-US | 10 | metric tons | USD/metric ton |
| Coffee | Coffee “C” | ICE-US | 37,500 | lbs. | U.S. cents/pound |
| Cotton | Cotton | ICE-US | 50,000 | lbs. | U.S. cents/pound |
| Sugar | World Sugar No. 11 | ICE-US | 112,000 | lbs. | U.S. cents/pound |

with the relevant contracts being determined as follows:
TABLE 2

| Commodity | | | | |
|---|---|---|---|---|
| Symbol | Commodity Name | Sector | Allowed Contracts | Max. tenor |
| CO | Brent Crude | Energy | All 12 Calendar Months | 12 |
| CL | Crude Oil | Energy | All 12 Calendar Months | 12 |
| QS | Gas Oil | Energy | All 12 Calendar Months | 12 |
| HO | Heating Oil | Energy | All 12 Calendar Months | 12 |
| NG | Natural Gas | Energy | All 12 Calendar Months | 12 |
| XB | RBOB | Energy | All 12 Calendar Months | 12 |
| FC | Feeder Cattle | Livestock | January, March, April, May, August, September, October, | 5 |
| | | | Novemeber | |
| LH | Lean Hogs | Livestock | February, April, June, July, August, October, December | 5 |
| LC | Live Cattle | Livestock | February, April, June, August, October, December | 5 |
| BO | Soybean Oil | Grains | January, March, May, July, August, September, October, | 7 |
| | | | December | |
| C | Corn | Grains | March, May, July, September, December | 12 |
| S | Soybeans | Grains | January, March, May, July, August, September, Novemeber | 12 |
| SM | Soymeal | Grains | January, March, May, July, August, September, October, | 7 |
| | | | December | |
| W | Wheat (Soft Red Winter) | Grains | March, May July, September, December | 7 |
| LA | Aluminum | Industrial Metals | All 12 Calendar months | 12 |
| HG | Copper | Industrial Metals | All 12 Calendar months | 12 |
| LL | Lead | Industrial Metals | All 12 Calendar months | 7 |
| LN | Nickel | Industrial Metals | All 12 Calendar months | 7 |
| LT | Tin | Industrial Metals | All 12 Calendar months | 7 |
| LX | Zinc | Industrial Metals | All 12 Calendar months | 7 |
| GC | Gold | Precious Metals | February, April, June, August, October, December | 12 |
| PL | Platinum | Precious Metals | January, April, July, October | 5 |
| SI | Silver | Precious Metals | March, May, July, September, December | 5 |
| CC | Cocoa | Softs | March, May, July, September, December | 7 |
| KC | Coffee | Softs | March, May, July, September, December | 7 |
| CT | Cotton | Softs | March, May July, December | 7 |
| SB | Sugar | Softs | March, May, July, October | 7 |

(b) identifying a first group of seven commodities having the highest percentage price difference as determined in step (a),
(c) for each commodity not in said first group identified in step (b), determining with a computer a percentage price change between the price of the closest-to-expiration eligible commodity futures contract and the price of the closest-to-expiration eligible commodity futures contract one year earlier,
(d) identifying a second group of seven commodities having the highest percentage price change as determined in step (c),
(e) combining the first and second groups of commodities from steps (b) and (d) to provide a provisional combined grouping,
(f) analyzing the commodities in the provisional combined grouping of step (e) to determine if a commodity is present from all six commodity sectors, and if not, replacing a commodity in said provisional combined grouping from said second group having the lowest percentage price change with a commodity from the omitted commodity sector which has the highest percentage price change to provide a finalized combined grouping, and
(g) for each of the commodities in the finalized combined grouping, selecting a specific Benchmark component commodity futures contract with a tenor of eligible tenors, and
(h) at the end of a trading day, multiplying the sum of the day's percentage price change for the commodity future of each commodity in the finalized combined grouping with an equivalent value from a business day earlier to provide SDCI ER, and
(i) multiplying the value of SDCI TR on the prior business day by one plus the sum of the value of the day's SDCI ER returns and one business day's interest from the hypothetical treasury bill portfolio.
